(19) United States
(12) Patent Application Publication
(10) Pub. No.: US 2008/0214031 A1
(43) Pub. Date: Sep. 4, 2008

(54) ELECTRICAL CONNECTOR

(75) Inventors: Shinya ISHIZUKA, Tokyo (JP); Akio YAMADA, Tokyo (JP); Kazuyuki OZAI, Tokyo (JP); Hiromichi KATO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DDK LTD., Tokyo (JP)

(21) Appl. No.: 12/037,832

(22) Filed: Feb. 26, 2008

(30) Foreign Application Priority Data
Mar. 2, 2007 (JP) 2007-52,564

(51) Int. Cl. H01R 13/62; H01R 9/03

(52) U.S. Cl. 439/153; 439/607

(57) ABSTRACT

An electrical connector includes a plurality of contacts to be connected to a cable, a housing for arranging and holding the contacts, a shell dividable into two shells covering the housing and having a holding device for holding the cable, and an insulating member covering the shell. One of the shells is provided with anchoring portions and the other shell is provided with engaging portions so that when both the shells are fitted with each other, the anchoring portions and the engaging portions are engaged with each other to bring both the shells into electrical continuity with each other. Therefore, the shells can be securely held together to achieve reliable electrical continuity between the shells, and at the same time grounding between the cable and the shell and between the shells themselves can be achieved.

### BACKGROUND OF THE INVENTION

The present invention relates to an electrical connector for use in electric and electronic appliances such as cell phones and the like, and more particularly to an electrical connector having a structure securely fixing two divided shells to each other and simultaneously achieving reliable electrical continuity between the shells.

An electrical connector hitherto used in the art will be explained. Such an electrical connector includes at least a plurality of contacts to be connected to a cable, a housing for arranging and holding the contacts, a shell dividable into two shells covering the housing and having holding means for holding the cable, and an insulating member covering the shell.

In order to combine the two shells in the prior art, the respective shells have been fixed to the housing, or the shells themselves are fixed to each other in a manner as disclosed in Patent Literature 1 described below.

As an example of electrical connectors, incorporated herein is the Patent Literature 1, Japanese Patent Application Opened No. H10-228,944 (1998) using a shell dividable into two shells, proposed by the applicant of the present application.

Patent Literature 1

According to the Abstract of the Japanese Patent Application Opened No. H10-228,944, this invention has an object to provide an electrical connector comprising a main body molded from a plastic material, a plurality of metal contacts incorporated in the main body, a divided main shell being substantially U-shaped and covering a part of the main body, and a divided sub-shell being substantially U-shaped and covering the other part of the main body. Disclosed is an electrical connector comprising a main body 100 molded from a plastic material, a plurality of metal contacts incorporated in the main body, a divided main shell 300 being substantially U-shaped and covering a part of the main body, and a divided sub-shell 400 being substantially U-shaped and covering the other part of the main body, thereby intending to achieve the simplification of the main body 100, the divided main shell 300, and the divided sub-shell 400.

For noise countermeasure in the past, a housing of an insulating material has generally been enclosed in a metal shell. In order to cover the housing by the shell, the shell has been divided into tow shells. In combining such two divided shells, the respective shells have in the past been fixed to the housing as described above, or the method disclosed in Patent Literature 1 has been employed. With both the methods, however, clearances at fitted portions between the shells would tend to increase, making it impossible to firmly fit the shells together. This problem remains to be solved.

Moreover, grounding has been frequently carried out by electrical continuity between a cable and a shell or between shells. In the case that the two shells are fixed to the housing as described above, however, it would be impossible to bring the two shells into electrical continuity. On the other hand, with the construction disclosed in the Patent Literature 1, although the two shells come into contact with each other to achieve their electrical continuity to some extent, the clearances at fitted portions between the shells as described above would provide an impediment to stable electrical continuity between the shells.

### SUMMARY OF THE INVENTION

In view of the problems of the prior art described above, the invention has been completed, and an object of the invention is to provide an electrical connector which eliminates all the disadvantages of the prior art, and achieves a strong fixation between two divided shells and a reliable electrical continuity between them, and simultaneously achieves grounding between a cable and the shells and between the shells.

The above object can be achieved by the electrical connector 10 according to the invention including a plurality of contacts 14 to be connected to a cable 40, a housing 12 for arranging and holding said contacts 14, a shell 16 dividable into two shells covering said housing 12 and having holding means for holding said cable 40, and an insulating member 20 covering said shell 16, wherein one of said shells 16 is provided with at least one anchoring portion 42 and the other shell 16 is provided with at least one engaging portion 44 so that when both the shells 16 are fitted with each other, said anchoring portion 42 and said engaging portion 44 are engaged with each other to bring both said shells 16 into electrical continuity with each other.

In the electrical connector 10 claimed in claim 2, said anchoring portion 42 of the one of said shells 16 is an anchoring groove 421, and said engaging portion 44 of the other shell 16 is an engaging protrusion 441 so that by inserting said engaging protrusion 441 into said anchoring groove 421, both said shells 161 and 162 are brought into electrical continuity.

In the electrical connector 10 claimed in claim 3, either of said shells 16 is provided with an anchoring hole 46, and the remaining shell 16 is provided with an engaging piece 48 so that when both the shells 16 are fitted with each other, said anchoring hole 46 and said engaging piece 48 are engaged with each other to bring both said shells 16 into electrical continuity.

Moreover, the electrical connector 10 claimed in claim 4 further comprises locking means for locking the electrical connector to a mating connector.

As can be seen from the above descriptions, the electrical connector 10 according to the invention can bring about the following significant effects.

(1) The connector 10 as claimed in claim 1 includes a plurality of contacts 14 to be connected to a cable 40, a housing 12 for arranging and holding said contacts 14, a shell 16 dividable into two shells covering said housing 12 and having holding means for holding said cable 40, and an insulating member 20 covering said shell 16, wherein one of said shells 16 is provided with at least one anchoring portion 42 and the other shell 16 is provided with at least one engaging portion 44 so that when both the shells 16 are fitted with each other, said anchoring portion 42 and said engaging portion 44 are engaged with each other to bring both said shells 16 into electrical continuity with each other.

Therefore, the invention can achieve a strong fixation between two divided shells 16 and a reliable electrical continuity between the shells, and further the invention can achieve grounding between the cable 40 and said shells 16 and between the shells 16.

(2) According to electrical connector 10 claimed in claim 2, said anchoring portion 42 of the one of said shells 16 is an anchoring groove 421, and said engaging portion 44 of the other shell 16 is an engaging protrusion 441 so that by inserting said engaging protrusion 441 into said anchoring groove 421, both said shells 161 and 162 are brought into electrical continuity. Accordingly, it is possible to achieve a strong fixation between two divided shells 16 and a reliable electrical continuity between the shells, and it is further possible to achieve grounding between the cable 40 and said shells 16 and between the shells 16.

(3) According to the electrical connector 10 claimed in claim 3, either of said shells 16 is provided with an anchoring hole 46, and the remaining shell 16 is provided with an engaging piece 48 so that both the shells 16 are fitted with each other, said anchoring hole 46 and said engaging piece 48 are engaged with each other to bring both said shells 16 into electrical continuity. Consequently, it is possible to achieve a strong fixation between two divided shells 16 and a reliable electrical continuity between the shells, and it is further possible to achieve grounding between the cable 40 and said shells 16 and between the shells 16. (4) The electrical connector 10 claimed in claim 4 further comprises locking means for locking the electrical connector to a mating connector. Therefore, the electrical connector 10 can be securely locked to the mating connector.

The invention will be more fully understood by referring to the following detailed specification and claims taken in connection with the appended drawings.

### BRIEF DESCRIPTION OF THE DRAWINGS

FIG. 1A is a perspective view of the electrical connector according to the invention, viewed from the fitting opening side;

FIG. 1B is a perspective view of the electrical connector shown in FIG. 1A viewed from the side of an extending cable;

FIG. 2A is a perspective view of the electrical connector with an insulating member removed, viewed from the fitting opening side;

FIG. 2B is a perspective view of the electrical connector shown in FIG. 2A with the insulating member removed, viewed from the side of the extending cable;

FIG. 3A is a sectional view of the electrical connector taken along a plane passing through one engaging protrusion of a shell;

FIG. 3B is a partly sectional view of the electrical connector taken along a locking member;

FIG. 4A is a perspective view of the shell in the state of a combination of two shells;

FIG. 4B is a perspective view of one of the shells;

FIG. 4C is a perspective view of the other shell;

FIG. 5 is a perspective view of a housing;

FIG. 6A is a perspective view of one of contacts;

FIG. 6B is a perspective view of the other contact; and

FIG. 7 is a perspective view of the locking member.

### DESCRIPTION OF THE PREFERRED EMBODIMENTS

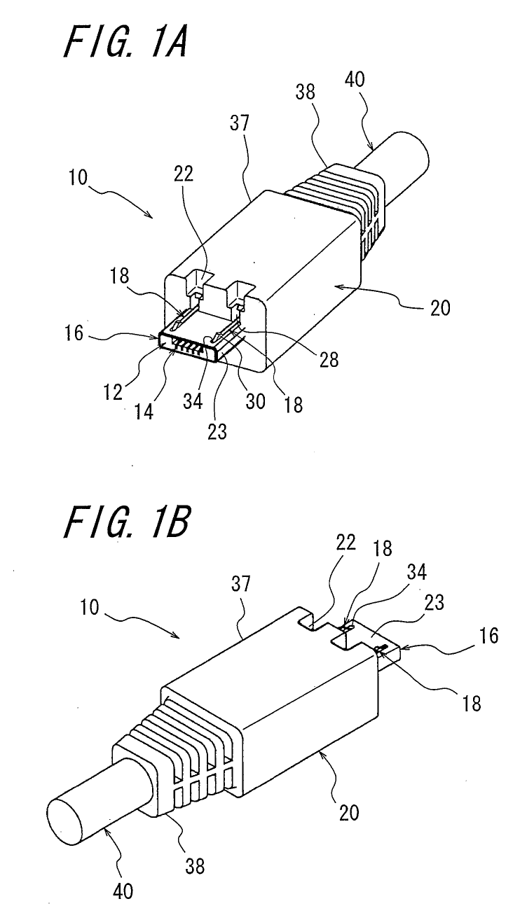

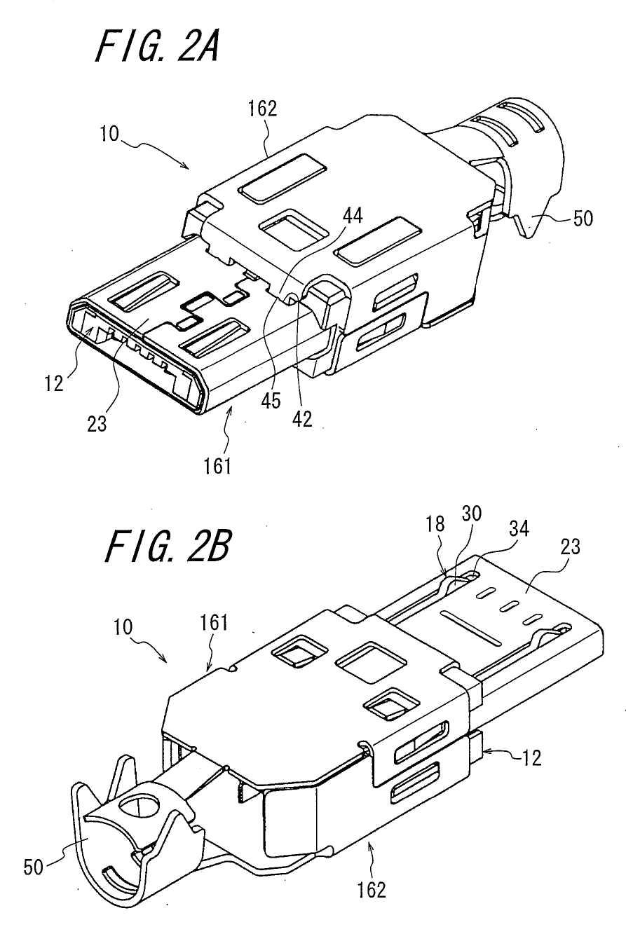

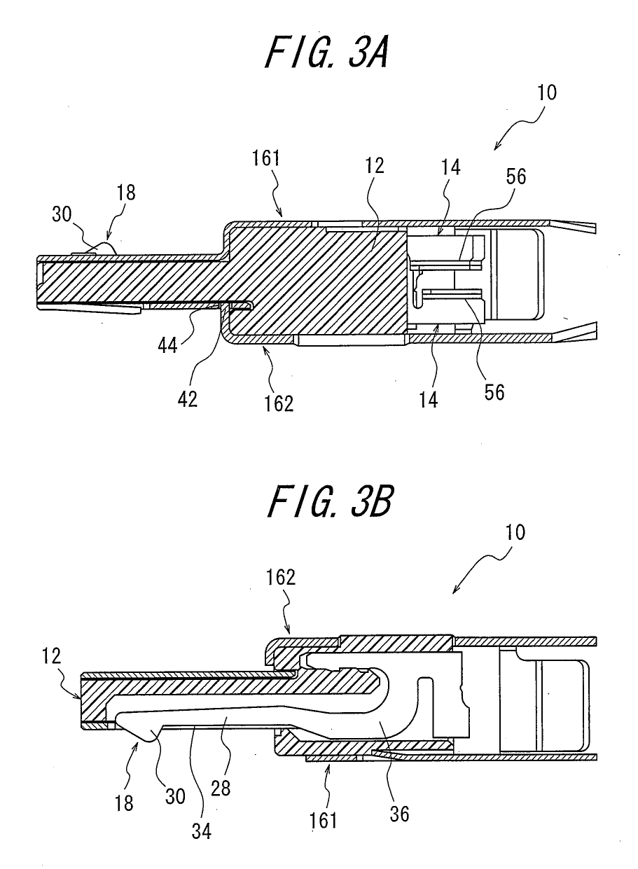

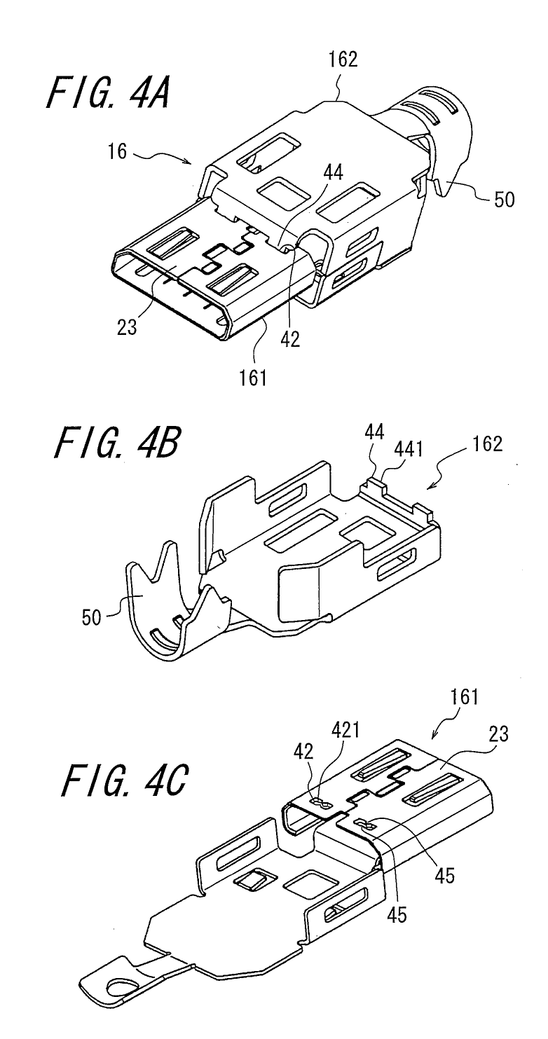

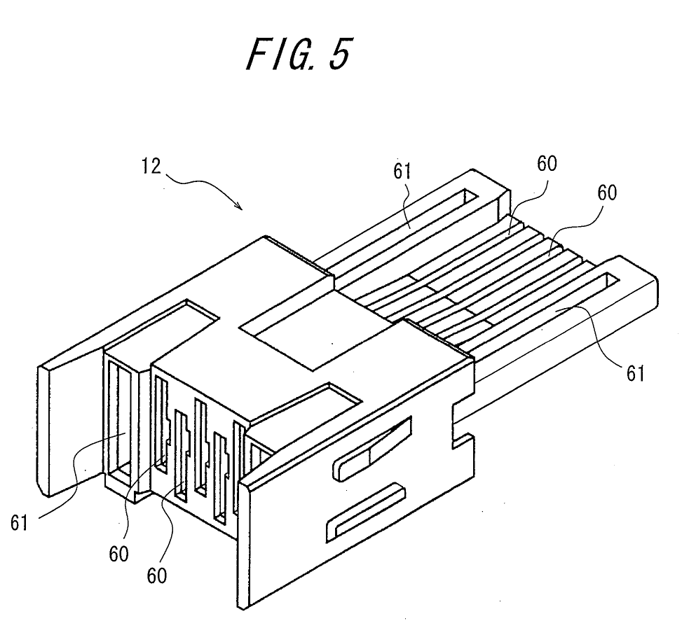

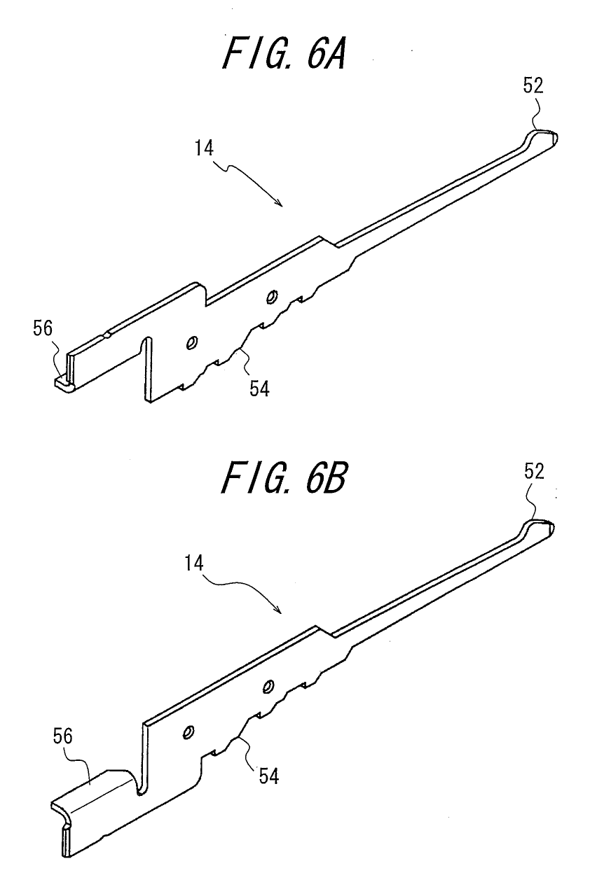

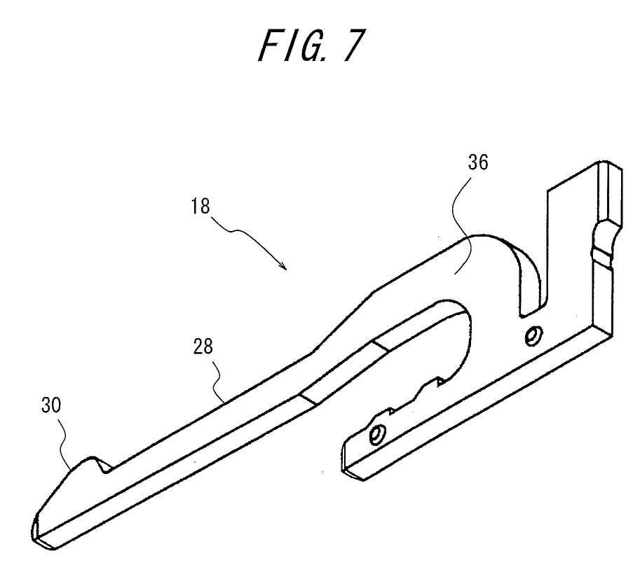

One embodiment of the electrical connector 10 according to the invention will be explained with reference to FIGS. 1A to 7. FIG. 1A is a perspective view of the electrical connector according to the invention viewed from the fitting opening side, and FIG. 1B is a perspective view of the electrical connector shown in FIG. 1A viewed from the side of an extending cable. FIG. 2A is a perspective view of the electrical connector with an insulating member removed, viewed from the fitting opening side, and FIG. 2B is a perspective view of the electrical connector shown in FIG. 2A with the insulating member removed, viewed from the side of the extending cable. FIG. 3A is a sectional view of the electrical connector taken along a plane passing through one engaging protrusion of a shell, and FIG. 3B is a partly sectional view of the electrical connector taken along a locking member. FIG. 4A is a perspective view of the shell in the state of a combination of two shells, while FIG. 4B is a perspective view of one of the shells and FIG. 4C is a perspective view of the other shell. FIG. 5 is a perspective view of a housing. FIG. 6A is a perspective view of one of contacts, and FIG. 6B is a perspective view of the other contact. FIG. 7 is a perspective view of the locking member.

The electrical connector 10 according to the invention comprises at least a plurality of contacts 14, a housing 12, a combined shell 16 dividable into two shells, locking members 18, and an insulating member 20.

First, the shell 16 dividable into two shells (shell A 161 and shell B 162) will be explained, forming one important aspect of the invention. These shells 16 (shell A 161 and shell B 162) are made of a metal and formed by means of the press-working of the known technique. A metal from which to form the shells is suitably selected in consideration of the requirements for the shells such as dimensional stability, workability, manufacturing cost, and the like, and preferred metals for the shells generally include brass, beryllium copper, phosphor bronze, and the like. The shell A 161 and shell B 162 to be combined into the shell 16 are substantially in the form of boxes, respectively, and said housing 12 is fixed to the inside of the combined shell 16 by means of hooking, or the like.

The combined shell 16 (the shell A 161 and the shell B 162) is provided at one end with a fitting opening 23 for fitting with a mating connector and at the other end with holding means for holding a cable 40. At the fitting opening 23, the shell A 161 is provided with anchoring portions 42 and the ether shell B 162 is provided with engaging portions 44. By engaging the anchoring portions 42 with the engaging portions 44, said shells 161 and 162 are firmly held and fixed to each other, and simultaneously brought into electrical continuity with each other with great certainty. In the illustrated embodiment, the fitting opening 23 is formed by the shell A 161, and a clamp portion 50 is provided as said holding means for embracing said cable 40. Said clamp portion 50 may be suitably designed taking into account a holding force required for the cable 40, and workability and the like of the shells. Moreover, the shell A 161 is formed on the side of said fitting opening 23 with notches 34 to expose displacing portions 28 of said locking members 18 (FIG. 2B and FIGS. 1A and 1B). Each of the notches 34 is a relief or space for allowing the displacing portion 28 of said locking member 18 to move without being interfered with by the shell. The size and shape of the notches 34 may be suitably designed in consideration of the function and the strength, workability, and the like of the shell.

In the illustrated embodiment, said shell 16 consists of the shell A 161 and the shell B 162 as described above. As shown in FIG. 4C, said shell A 161 is formed with anchoring grooves 421 as said anchoring portions 42, while as shown in FIG. 4B, said shell B 162 is formed with engaging protrusions 441 as said engaging portions 44. As shown in FIG. 4B, the tips of said engaging protrusions 441 are formed in raised shapes, and when the raised tips are fitted into said anchoring grooves 421 by light-press fitting, said shell A 161 and shell B 162 are firmly held and fixed to each other, and simultaneously brought into electrical continuity with each other with great certainty. In more detail, two projections 45 are provided in each of the anchoring grooves 421 so that the engaging protrusion 441 is embraced between the two projections 45, thereby achieving the light-press fitting of the engaging protrusion 441 in the anchoring groove 421. The shapes and sizes of said anchoring grooves 421 and said engaging protrusions 441 may be suitably designed in consideration of such a function, strengths of these parts, miniaturization of the connector 10, and the like.

Further, either of said shell A 161 and shell B 162 is formed with anchoring holes, while the other shell is provided with engaging pieces. In the illustrated embodiment, said shell A 161 is provided on both side walls with said engaging pieces, and said shell B 162 is formed in both side walls with said anchoring holes. By engaging said engaging pieces of said shell A 161 with said anchoring holes of said shell B 162, the shell A 161 and shell B 162 are more securely held together in more reliable electrical continuity. Said anchoring holes are formed in the side walls as through-holes by punching in the step of press-working of the shell, while said engaging pieces are formed on the side walls by forming slits and bending or raising the parts formed by the slits in the step of press-working of the shell. The engaging pieces of said shell A 161 are bent or raised in the direction of the thickness of the sidewalls. The shapes and sizes of said anchoring holes and said engaging pieces may be suitably designed taking into account their function and strengths, the miniaturization of the connector 10, and the like. Although said engaging pieces are provided on said shell A 161 and said anchoring holes are formed in said shell B 162 in the embodiment, it is to be understood that said engaging pieces may be provided on said shell B 162 and said anchoring holes may be formed in said shell A 161. Said engaging pieces and said anchoring holes are not shown in the drawings.

The housing 12 will then be explained. The housing 12 is formed from an electrically insulating plastic material by means of the injection molding of the known technique. A material from which to form the housing is suitably selected in consideration of dimensional stability, workability, manufacturing cost and the like, and preferable materials for the housing generally include polybutylene terephthalate (PBT), polyamide (66PA or 46PA), liquid crystal polymer (LCP), polycarbonate (PC) and the like and combination thereof. Said housing 12 includes inserting holes 60 into which the contacts 14 are inserted. Said inserting holes 60 need only be able to hold said contacts 14. The sizes and shapes of the inserting holes 60 may be suitably designed talking into account the sizes and shapes of said contacts 14, the miniaturization of the connector 10, and the strength of the housing 12. Moreover, said housing 12 has inserting apertures 61 for inserting the locking members 18 therein, respectively. The inserting apertures 61 also need only be able to hold said locking members 18, respectively. The size and shape of the inserting apertures 61 may be suitably designed talking into account the size and shape of said locking members, the miniaturization of the connector 10, and the strength of the housing 12.

The contacts 14 will then be explained. The contacts 14 are made of a metal and formed by means of the press-working of the known technique. Preferred metals from which to form the contacts 14 generally include brass, beryllium copper, phosphor bronze, and the like because of requirements for the contacts such as dimensional stability, electric conductivity, and the like. The contact 14 mainly comprises a contact portion 52 adapted to contact a mating connector, a fixed portion 54 to be held in the housing 12, and a connection portion 56 to be connected to the cable 40, and is substantially in the form of a plate piece. In the illustrated embodiment, two kinds of contacts 14 are used and alternately arranged. Said contact portions 52 are adapted to contact mating objects such as contacts of the mating connector, and their shapes and sizes may be suitably designed taking into account contact stability and contact pressure with the mating objects, workability of the contacts, and the like. The contact portions are shaped into protrusions in the illustrated embodiment. Said fixed portions 54 are held in the housing 12 by press-fitting, hocking (lancing), or welding. The contacts 14 are fixed to the housing by press-fitting in the illustrated embodiment. Said connection portions 56 are adapted to be connected to the cable 40, and their shapes may be suitably designed in consideration of specifications, the mating objects, connecting methods, and the like. The connection portions are connected to the cable 40 by soldering in the illustrated embodiment.

The insulating member 20 will then be explained. There are two cases for forming the insulating member 20. In one case, the insulating member 20 is formed integrally with said shell A 161 and said shell B 162, and in the other case, the insulating member 20 is formed separately from the shells and these shells in this case are embraced and fixed in the insulating member. In either case, the insulating member 20 is formed from an electrically insulating plastic material by means of the injection molding of the known technique. In the case of integral molding, the material of the insulating member is suitably selected taking into account the countermeasure against static electricity, workability, manufacturing cost, and the like, and polyvinyl chloride (PVC) is generally used. In the case of forming as a separate member, a material from which to form the insulating member 20 is suitably selected in consideration of dimensional stability, workability, manufacturing cost, and the like, and preferable materials for the insulating member 20 generally include polybutylene terephthalate (PBT), polyamide (66PA or 46PA), polycarbonate (PC) and the like and combination thereof. The insulating member 20 is integrally formed with the shell taking into account the countermeasure against static electricity in the illustrated embodiment. Said insulating member 20 comprises at least a bellows portion 3 8 for restraining the cable 40, and a main body 37.

The bellows portion 38 serves to partly restrain the cable 40 extending from said shells 16 by a metal sleeve located inside the bellows portion 38, thereby preventing said cable 40 from positioning eccentrically. The bellows portion also serves to increase the flexibility of the cable 40. The shape and size of said bellows portion 38 may be suitably designed taking into account the functions described above, the flexibility and workability of the insulating member 20, and the like.

Said main body 37 covers or encloses said shell 16 for the countermeasure against static electricity and is formed with recesses 22 at locations opposite from said bellows portion 38 and corresponding to the displacing portions 28 of said locking members 18. Said recesses 22 serve to prevent the material of the insulating member 20 from flowing onto the displacing portions 28 of said locking member 18 exposed to the surface of the shell 16. The shape and size of said recesses 22 may be any ones insofar as they fulfill their role, and may be suitably designed taking into account the countermeasure against static electricity, workability, strength, and size of the locking members 18, and the like. Said recesses 22 are arranged at locations corresponding to said locking members 18.

Finally, the locking members 18 will be explained. The locking members 18 are made of a metal and formed by means of the press-working of the known technique. Preferred metals from which to form the locking members 18 generally include brass, beryllium copper, phosphor bronze, and the like because of the requirements for the locking members 18 such as dimensional stability, electric conductivity, and the like. Said locking member 18 mainly comprises an engaging part 30 adapted to engage the mating connector, the displacing portion 28, and an elastic portion 36 enabling the displacing portion 28 to be elastically displaceable. The shapes and sizes of said engaging part 30, the displacing portion 28 and the elastic portion 36 need only enable said locking members 18 to engage the mating connector and may be suitably designed taking into account the miniaturization and reduced overall height of the connector, holding force, workability, and the like. The two locking members 18 of a pair are so arranged that said displacing portions 28 are exposed to the upper surface of the fitting opening 23 of said shell 16 in the illustrated embodiment. The two locking members are arranged so as to form the pair of locking members, thereby achieving a stable fitting with the mating connector.

The examples of applications of the invention are electrical connectors for use in electric and electronic appliances such as cell phones, and particularly connectors having a structure strongly fixing two divided shells to each other and simultaneously achieving reliable electrical continuity between the shells.

While the invention has been particularly shown and described with reference to the preferred embodiments thereof, it will be understood by those skilled in the art that the foregoing and other changes in form and details can be made therein without departing from the spirit and scope of the invention.

1. An electrical connector including a plurality of contacts to be connected to a cable, a housing for arranging and holding said contacts, a shell dividable into two shells covering said housing and having holding means for holding said cable, and an insulating member covering said shell,
wherein one of said shells is provided with at least one anchoring portion and the other shell is provided with at least one engaging portion so that when both the shells are fitted with each other, said anchoring portion and said engaging portion are engaged with each other to bring both said shells into electrical continuity with each other.

2. The electrical connector as claimed in claim 1, wherein said anchoring portion of the one of said shells is an anchoring groove, and said engaging portion of the other shell is an engaging protrusion so that by inserting said engaging protrusion into said anchoring groove, both said shells are brought into electrical continuity.

3. The electrical connector as claimed in claim 1, wherein either of said shells is provided with an anchoring hole, and the remaining shell is provided with an engaging piece so that when both the shells are fitted with each other, said anchoring hole and said engaging piece are engaged with each other to bring both said shells into electrical continuity.

4. The electrical connector as claimed in claim 1, further comprising locking means for locking the electrical connector to a mating connector.

5. The electrical connector as claimed in claim 2, wherein either of said shells is provided with an anchoring hole, and the remaining shell is provided with an engaging piece so that when both the shells are fitted with each other, said anchoring hole and said engaging piece are engaged with each other to bring both said shells into electrical continuity.

6. The electrical connector as claimed in claim 2, further comprising locking means for locking the electrical connector to a mating connector.

7. The electrical connector as claimed in claim 3, further comprising locking means for locking the electrical connector to a mating connector.

8. The electrical connector as claimed in claim 5, further comprising locking means for locking the electrical connector to a mating connector.
